(19) United States
(12) Patent Application Publication
(10) Pub. No.: US 2009/0064589 A1
(43) Pub. Date: Mar. 12, 2009

(54) Brake Shoe Assembly For Sash Window Assembly

(75) Inventor: Michael A. Tyler, Mokena, IL (US)

Correspondence Address: BANNER & WITCOFF, LTD., TEN SOUTH WACKER DRIVE, SUITE 3000, CHICAGO, IL, 60606, US

(73) Assignee: NEWELL OPERATING COMPANY, Atlanta, GA (US)

(21) Appl. No.: 11/854,345

(22) Filed: Sep. 12, 2007

(51) Int. Cl. E05D 15/24

(52) U.S. Cl. 49/181

(57) ABSTRACT

A brake shoe assembly is mounted in a sash window assembly. The sash window assembly has a sash window slidably supported within a master frame and the master frame has tracks. The brake shoe assembly has a slider body adapted to be received in the track of the master frame. The slider body has a central opening and further has an upper opening in communication with the central opening. A cam is positioned in the central opening and is adapted to receive a pivot pin attached to the sash window. A clip is positioned in the upper opening. The clip is accessible from proximate a top of the slider body for connection to and removal from the slider body.

### CROSS-REFERENCE TO RELATED APPLICATIONS

None.

### FEDERALLY SPONSORED RESEARCH OR DEVELOPMENT

Not applicable.

### TECHNICAL FIELD

The present invention relates to sash window hardware and, more particularly, to a brake shoe assembly for use in sash windows.

### BACKGROUND OF THE INVENTION

A pivotal sash window adapted for installation in a master frame of a sash window assembly is well-known. The pivotal sash window assembly typically has opposed, vertically extending jambs or guide rails to enable vertical reciprocal sliding movement of the sash window in the master frame while cooperatively engaged with the guide rails. The sash window also has a top sash rail, a base or lower rail and a pair of stiles or side rails cooperatively connected together at adjacent extremities thereof to form a sash frame, usually a rectangular frame.

Hardware is associated with the sash window assembly, such as a sash lock that provides a locking mechanism between an upper sash window and a lower sash window, as well as tilt-latches that releasably engage the guide rails to allow the sash window to pivot from the master frame. Additional hardware in the form of a sash balance brake assembly is also typically included and includes a balance spring and brake shoe assembly. The balance spring provides an upward biasing force to the sash window. The brake shoe assembly is slidingly received in tracks on the master frame and pivotally supports the sash window. The brake shoe assembly typically has a cam that is rotatably supported in a housing, or slider body, and receives a pivot pin extending from the sash window. The brake shoe assembly further has a brake pad that engages the track when the sash window is pivoted from the master frame to prevent the sash window from springing upwards due to the upward bias provided by the balance spring.

During shipment of the sash window assembly as well during operation, the pivot pins can inadvertently disengage from the cam of the brake shoe. Certain mechanisms have been provided to prevent this disengagement. While such mechanisms provide a number of advantageous features, they nevertheless have certain limitations. The present invention seeks to overcome certain of these limitations and other drawbacks of the prior art, and to provide new features not heretofore available.

### SUMMARY OF THE INVENTION

The present invention provides a brake shoe assembly for a sash window assembly. The sash window assembly has a sash window slideable within a master frame. The sash window has a top rail, a base, and two stiles connected together at their extremities. The sash window assembly further utilizes a brake shoe assembly.

According to an aspect of the invention, the brake shoe assembly has a slider body adapted to be received in the track of the master frame. The slider body has a central opening and further has an upper opening in communication with the central opening, A cam is positioned in the central opening. The cam is adapted to receive a pivot pin attached to the sash window. A clip is positioned in the upper opening. The clip is accessible from proximate a top of the slider body for connection to and removal from the slider body.

According to another aspect of the invention, the clip has a base and a leg extending from the base. The leg engages the slider body.

According to a further aspect of the invention, the slider body has an upper portion having a recess. The leg has a projection extending therefrom wherein the projection is received by the recess. The recess defines a slider body engagement surface and the projection defines a clip engagement surface wherein the clip engagement surface engages the slider body engagement surface to prevent removal of the clip from the slide body.

According to another aspect of the invention, the leg is flexible from a first position to a second position wherein the projection is removed from the recess allowing removal of the clip from the slider body.

According to yet another aspect of the invention, the base defines an abutment surface in confronting relation to the cam. The base is adapted to prevent removal of the pivot bar from the cam through the upper opening. In one exemplary embodiment, the abutment surface has a convex shape facing the central opening.

According to a further aspect of the invention, the clip has a base. A first flexible leg extends from the base and a second flexible leg extends from the base wherein the legs engage the slider body.

According to yet another aspect of the invention, the first leg has a first projection extending therefrom and the second leg has a second projection extending therefrom. The slider body has an upper portion having a first member and a second member wherein the upper opening is defined therebetween. The first member has a first recess and the second member has a second recess. The first projection is received by the first recess and the second projection is received by the second projection. In an exemplary embodiment, the first leg is flexible and the second leg is flexible where upon placing the first leg and the second leg in a flexed position, the first projection is removed from the first recess and the second projection is removed from the second recess allowing the clip to be removed from the slider body.

According to a further aspect of the invention, the first leg has a first tab extending therefrom and the second leg has a second tab extending therefrom. The tabs are engaged to place the first leg and the second leg in a flexed position. In an exemplary embodiment, the tabs are engaged simultaneously to place the first leg and second leg in the flexed position.

According to another aspect of the invention, the base has an extension member extending beyond the first leg and the second leg.

These and other objects and advantages will be made apparent from the following description of the drawings and detailed description of the invention.

### BRIEF DESCRIPTION OF THE DRAWINGS

To understand the present invention, it will now be described by way of example, with reference to the accompanying drawings in which:

FIG. 1 is a perspective view of a sash window assembly incorporating a brake shoe assembly of the present invention;

FIG. 2 is an exploded front view of the brake shoe assembly of the present invention;

FIG. 3 is an exploded rear view of slider body and anti-take-out clip of the brake shoe assembly of the present invention;

FIG. 4 is a front view of the anti-take-out clip used in the brake shoe assembly;

FIG. 5 is a side view of the anti-take-out clip shown in FIG. 4;

FIG. 6 is a rear view of the anti-take-out clip shown in FIG. 4

FIG. 7 is a front perspective view of the brake shoe assembly shown in FIG. 2 in an assembled configuration; and

FIG. 8 is a front plan view of the brake shoe assembly shown in FIG. 7.

### DETAILED DESCRIPTION

While this invention is susceptible of embodiment in many different forms, there is shown in the drawings, and will herein be described in detail, preferred embodiments of the invention with the understanding that the present disclosure is to be considered as an exemplification of the principles of the invention and is not intended to limit the broad aspect of the invention to the embodiments illustrated.

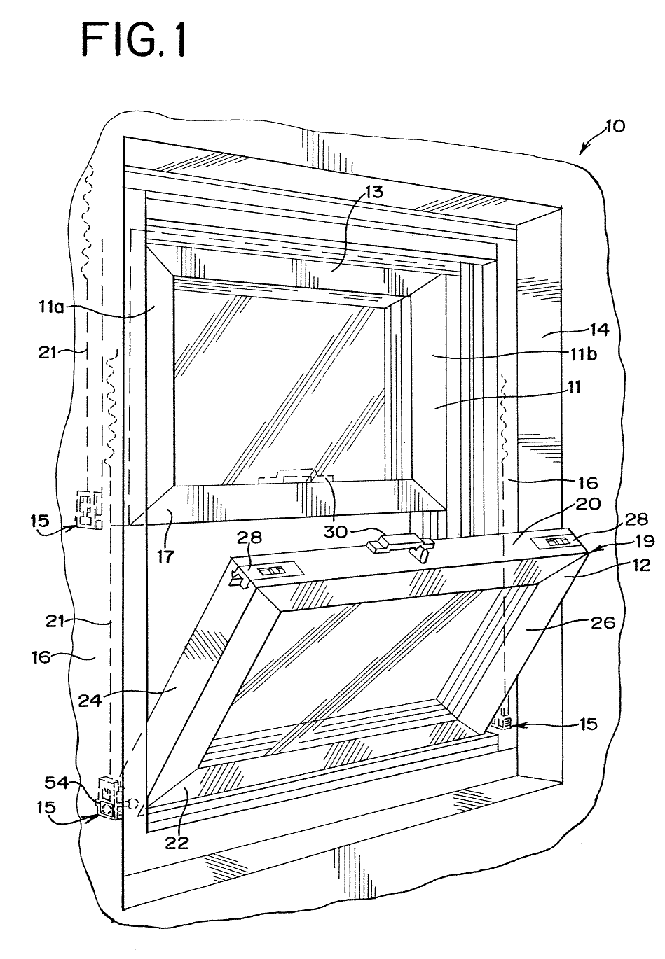

A sash window assembly 10 is shown in FIG. 1. The sash window assembly 10 is a double-hung window assembly having a pivotal bottom sash window 12 installed in a master frame 14. The bottom sash window 12 is pivotally mounted to the master frame 14 by a brake shoe assembly 15. The brake shoe assembly 15 cooperates with an overall window balance assembly that typically includes a balance spring 21 that provides an upward biasing force to the sash window 12. The balance spring 21 can take a variety of different forms as is known in the art. In one exemplary embodiment, the spring is a coil spring having a coiled end and a free end. In this embodiment, the coiled end is fixed within a track or shoe channel in the master frame and the free end is connected to the brake shoe assembly 15. If desired, multiple coil springs can be employed in the sash window assembly as desired by the designer. The brake shoe assembly 15 will be described in greater detail below. The master frame 14 has opposed, vertically extending guide rails 16 or jambs 16. The structure of the jambs 16 define the track or shoe channels that receive the brake shoe assembly 15 for slidable movement therein. The bottom sash window 12 has a top sash rail 20, a base 22 or bottom sash rail 22 and a pair of stiles 24,26 or side rails 24,26, cooperatively connected together at adjacent extremities thereof to form a sash frame 19, which is typically rectangular, although other shapes are possible. The sash frame 19 is typically made from vinyl extrusions known in the art. While the present invention can be used with any type of frame 19, the present invention is most preferably used with a window assembly 10 having a frame 19 made of vinyl. Further, it is contemplated that the frame 19 could be made from wood, masonite or press board, or from extrusions or pulltrusions that are filled with fiberglass, epoxy, plastic, or wood chips, or from other materials, including aluminum. The window assembly 10 also preferably has a top sash window 11, which is similar in structure to the bottom sash window 12, having a top rail 13, a bottom rail 17, and two stiles 11a,11b.

Other hardware may also be included in the sash window assembly. For example, the sash window assembly may include a pair of tilt-latches 28 that when disengaged from the master frame 14, allow the sash window 12 to pivot from the master frame 14 as shown in FIG. 1. A sash lock assembly 30 may also be included that locks the bottom sash window 12 and the top sash window 11. If desired, the tilt-latches 28 and sash lock 30 can be integrated into a single assembly.

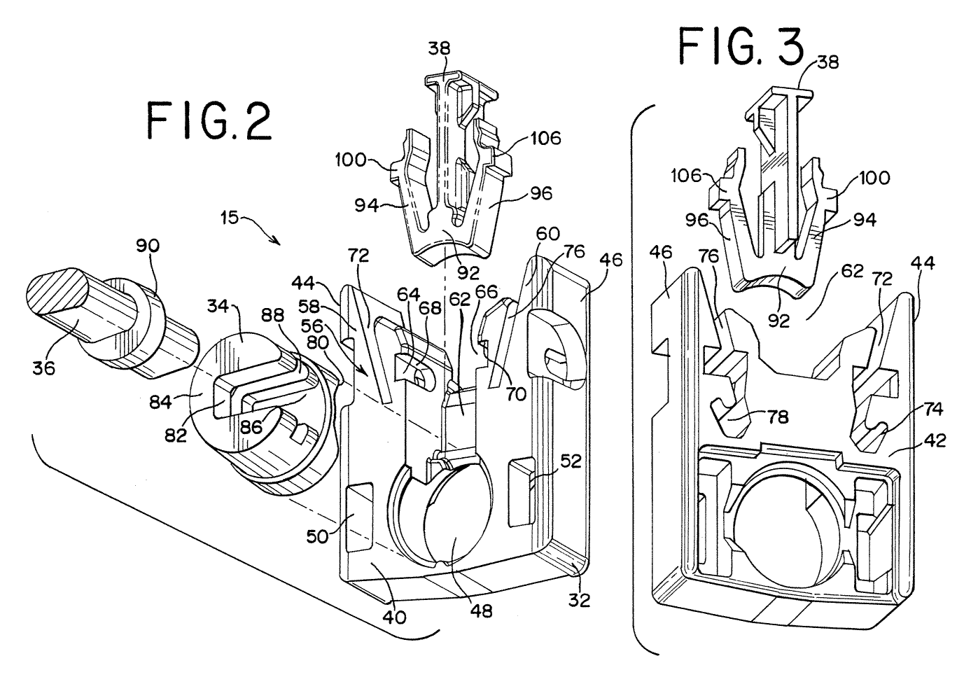

As shown in FIGS. 2 and 3, the brake shoe assembly 15 generally includes a slider body 32, a cam 34, a pivot bar 36 and a clip 38, which may be referred to as an anti-take-out clip 38. The anti-take-out clip 38 prevents unwanted removal of the pivot bar 36 from the cam 34 and slider body 32 as described in greater detail below.

The slider body 32, which may also be referred to as shoe or a housing 32, generally has a block-shaped configuration. The slider body 32 has a front wall 40, a rear wall 42 and two side walls 44,46, which cooperate to form the housing 32 or slider body 32. The slider body 32 has a central opening 48 passing through the slider body 32 from the front wall 40 to the rear wall 42. The central opening 48 has generally a circular configuration dimensioned to receive the cam 34 as described in greater detail below. The slider body 32 further has a pair of openings 50,52 that receive fingers of a brake pad 54 (the brake pad shown schematically in FIG. 1). As is known, the brake pad 54 is supported by the slider body 32 and engaged by the cam 34 when the sash window 12 is pivoted from the master frame 14 wherein the brake pad 54 moves outwardly from the slider body 32 and applies a braking force against the track 16. It is understood that if desired, the brake pad 54 could be eliminated while still referring to the assembly as a brake shoe assembly 15.

The slider body 32 further has an upper portion 56 having a first member 58 and a second member 60. An upper opening 62 is defined between the first member 58 and the second member 60. The upper opening 62 is generally located in the upper portion 56 and is in communication with the central opening 48. Thus, access to the central opening 48 not only can be gained through the front wall 40 or the rear wall 42, access can also be gained from a top of the slider body 32 through the upper opening 62. As further shown in FIGS. 2 and 3, the first member 58 has a first recess 64 and the second member 60 has a second recess 66. The recesses 64, 66 face into and in communication with the upper opening 62. The first recess 64 defines a first slider body engagement surface 68 and the second recess 66 defines a second slider body engagement surface 70. It is understood that the shapes and particular locations on the first member 58 and the second member 60 can vary as desired. The first member 58 and the second member 60 further have tapered configurations into the upper opening 62.

As further shown in FIGS. 2 and 3, the first member 58 has a first slot 72 having a curved end 74 and the second member 60 has a second slot 76 having a second curved end 78. The slots 72, 76 preferably do not pass completely through the slider body 32 but are completely open in the rear wall 42. As shown in FIG. 2, only a portion of the slots 72, 76 are accessible in the front wall 40. As is known, the slots 74, 76 receive free ends of coil balance springs 21. The balance springs 21 have a coiled portion fixed to the track 16 and a curved free end generally corresponding in shape to the slots 72, 76 wherein the curved ends 74, 78 retain the springs 21 in connection with the slider body 32 without the use of a fastener. It is understood other connection methods such as the use of separate fasteners can be utilized between the slider body 32 and the springs 21. Interference fits can also be employed between the slider body 32 and springs 21. In addition, it is understood that other types of balance springs 21 can be used with the slider body 32. The brake shoe assembly 15 or slider body 32 may have additional features such as shown in commonly-owned U.S. Pat. No. 6,983,513, which is expressly incorporated herein by reference and made a part hereof.

The cam 34 has a generally circular outer periphery and is generally dimensioned to fit within the central opening 48. At one end, the cam 35 has camming surfaces 80 that cooperate with the brake pad 54 as is known. As can be appreciated from FIG. 2, the cam 34 and central opening 48 are configured so that the cam can pass into the central opening 48 only through the rear wall 42 of the slider body 32. Thus, the cam 34 cannot pass into the central opening 48 through the front wall 40 of the slider body 32. Furthermore, the cam 34 and slider body 34 are configured such that once the cam 34 is installed in the central opening 48, the cam 34 cannot pass out of the front wall 40 of the slider body 32. Thus, once installed, the cam 34 can only be removed from the central opening 48 through the rear wall of the slider body 32.

The cam 34 further has a cam slot 82 that extends into the cam 34 from a front face 84. The slot 82 also extends to a peripheral surface of the cam 34 defining a peripheral opening 86. The slot 82 further has a channel 88 in communication with the slot 82, and extending beyond the slot 82. The pivot bar 36 is an elongated structure and as is known, is connected to the sash window 12. The pivot bar 36 is dimensioned to be received and supported by the slot 82 of the cam 34. The pivot bar 36 has a collar 90 proximate a distal end that fits into the channel 88. As can be appreciated from FIG. 2, this prevents the pivot bar 36 from being slid out of the cam 32 from the front face 84 of the cam 34.

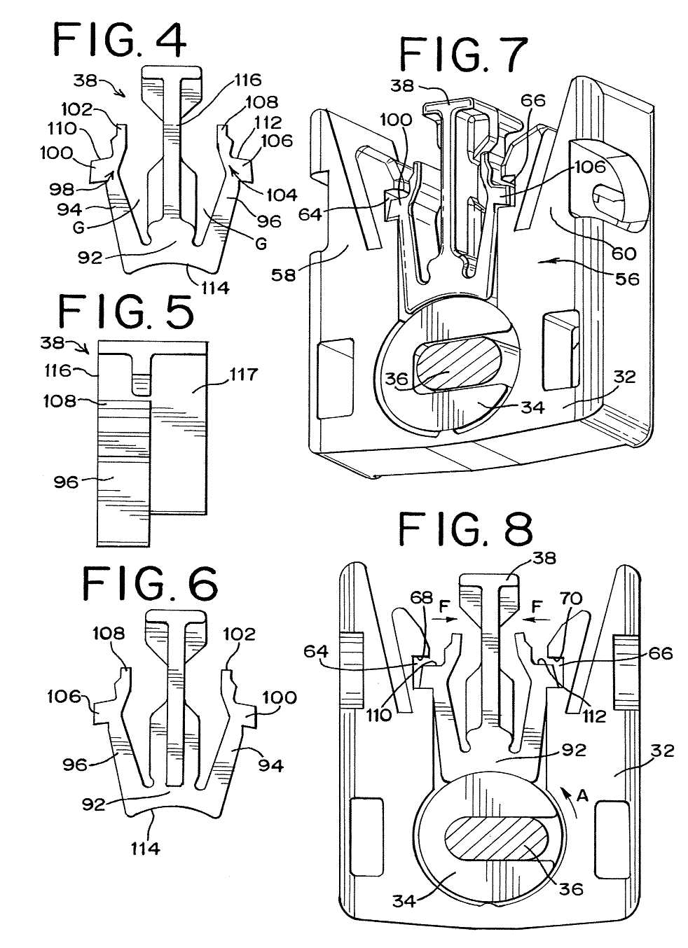

FIGS. 2-6 further show the clip 38. The generally includes a block or base 92 having a first leg 94 extending from the base 92 and a second leg 96 extending from the base 92. As described in greater detail below, the first leg 94 and the second leg 96 are resiliently flexible and gaps G are maintained between the legs 94, 96 and the base 92. The first leg 94 and second leg 96 extend upwardly and outwardly from the base 92 at an angle. This angle can vary but is generally an acute angle. The first leg 94 has a distal end 98 wherein a first projection 100 extends from the first leg 94 generally at the distal end 98. The first projection 100 extends outwardly from the first leg 94. A first tab 102 also extends from the distal end 98 but upwardly from the first leg 94. The first tab 102 has a varying surface defining an apex. Similarly, the second leg 96 has distal end 104 wherein a second projection 106 extends from the second leg 96 generally at the distal end 104. The second projection 106 extends outwardly from the second leg 96. A second tab 108 also extends from the distal end 104 of the second leg 96 but upwardly from the second leg 96. The second tab 108 also has a varying surface defining an apex. The first projection 100 defines a first clip engagement surface 110 and the second projection 106 defines a second clip engagement surface 112. As further shown, the base 92 has a bottom surface that defines an abutment surface 114 that is generally convex in shape. The base 92 further has an upwardly extending extension member 116 that extends beyond the tabs 102, 108. The extension member 116 has a ridge 117 at a rear end adding rigidity. Other flange structures along the extension member 116 add further rigidity.

As previous discussed, the cam 34 is installed into the central opening 48 of the slider body 32. The slider body 32 with the installed cam 34 is installed in the track 16 of the master frame 14 and is slidable within the track 16. As can be appreciated from FIGS. 2, 7 and 8, the cam 34 is rotated wherein the peripheral opening 86 of the cam 34 is generally aligned with the upper opening 62. In this configuration, the cam 34 can receive the pivot bar 36 when the sash window 12 is installed into the master frame 14. In particular, the pivot bar 36 is received in the cam slot 82 and the collar 90 is received in the channel 88. This configuration pivotally connects the sash window 12 to the slider body 32 as the cam 34 is rotatably supported in the central opening 48 of the slider body 32. It is desirable to prevent inadvertent or unwanted removal of the pivot bar 36 from the cam 34. The clip 38 is installed in the slider body 32 for this purpose. As can be appreciated from FIGS. 2, 3 7 and 8, the clip 38 is inserted into the upper opening 62 generally from a top of the slider body 32. Inserting the clip 38 from proximate the top of the slider body 32 is a more efficient and easier installation as attempting to insert a device from a front, or front face of the slider body 32 is oftentimes difficult because clearance in this area is minimal with the sash window 12 installed into the master frame 14. The first leg 94 and the second leg 96 are resiliently flexible and as the clip 38 is inserted, the legs 94, 96 are placed in a flexed position wherein the legs 94, 96 move towards the base 92 and extension member 116. Once fully inserted into the upper opening 62, the legs 94, 96 snap back to its unflexed position wherein the first projection 100 of the first leg 94 is received by the first recess 64. Likewise, the second projection 106 of the second leg 96 is received by the second recess 66. The base 92 extends to the central opening 48 and is generally in confronting relation to the cam 34. As shown in FIGS. 7 and 8, the convex surface 114 of the base 92 generally corresponds to the outer peripheral surface of the cam 34. In this assembled configuration, if the sash window 12 is placed in a position wherein the slot 82 is generally aligned with the upper opening 62 (e.g., if the cam 34 is rotated via arrow A such as when the sash window is pivoted to an open position), the clip 38 prevents the pivot bar 36 from being disengaged from the cam 34. If the pivot bar 36 is attempted to be removed from the cam 34, the pivot bar 36 will engage the abutment surface 114 of the base 92. Similarly, the first clip engagement surface 110 will engage the first slider body engagement surface 68, and the second clip engagement surface 112 will engage the second slider body engagement surface 70. These engagements and abutments prevent the pivot bar 36 from being removed from the cam 34. Thus, the clip 38 functions as an anti-take-out clip 38. While certain clearances are shown in FIG. 8 between the projections 100, 106 and recesses 64, 66, these structures can be modified to eliminate these clearances if desired.

In certain instances, the sash window 12 is required to be removed from the master frame 14 such as for general maintenance or other necessary repairs to the sash window assembly or components thereof. In this instance, the clip 38 can be easily removed as desired by an operator. To this end, an operator can engage, generally simultaneously, the first tab 102 and the second tab 108. The tabs 102, 108 are squeezed together (such as with a single operator hand) toward the extension member 116 to place the first leg 94 and the second leg 96 in a flexed position, such as can be appreciated from the arrows F in FIG. 8. The legs 94, 96 moved into the gaps G. As can be appreciated, in the flexed position, the first projection 100 is removed from the first recess 64, and the second projection 106 is removed from the second recess 66. In this position, the clip 38 can be removed from the slider body 32 wherein the upper opening 62 is no longer obstructed. It is understood that in this fashion, the clip 38 is accessible from proximate a top of the slider body 32 so that the clip 38 can be removed from the slider body 32. This configuration provides easier access to the clip 38. Once the sash window assembly is ready to be placed back into a completely assembled position, the clip 38 can be reinserted into the upper opening 62 as described above. Accordingly, the clip 38 is accessible from proximate a top of the slider body 32 for connection to and removal from the slider body 32.

The anti-take-out clip 38 used with the brake shoe assembly 15 prevents the pivot pin 36 from becoming inadvertently disengaged with the cam 34. The unique design further allows the anti-take-out clip to be accessed from proximate a top of the slider body 32. This allows the anti-take-out clip 38 to more easily be removed from the slider body 32 when desired by a user such as when removing the sash window from the master frame 14 for maintenance or repair. The design further allows the anti-take-out clip 38 to be easily re-installed into the slider body 32 when desired. Other devices that must be installed and removed such as from a front face of the slider body are cumbersome and oftentimes difficult because clearances are limited.

While the specific embodiments have been illustrated and described, numerous modifications come to mind without significantly departing from the spirit of the invention and the scope of protection is only limited by the scope of the accompanying Claims.

What is claimed is:

1. A brake shoe assembly for a sash window assembly having a sash window slidably supported within a master frame, the master frame having tracks, the brake shoe assembly comprising:
a slider body adapted to be received in the track of the master frame, the slider body having a central opening, the slider body further having an upper opening in communication with the central opening;
a cam positioned in the central opening, the cam adapted to receive a pivot pin attached to the sash window; and
a clip positioned in the upper opening, the clip being accessible from proximate a top of the slider body for connection to and removal from the slider body.

2. The brake shoe assembly of claim 1 wherein the clip has a base and a leg extending from the base, the leg engaging the slider body.

3. The brake shoe assembly of claim 2 wherein the slider body has an upper portion having a recess and the leg has a projection extending therefrom wherein the projection is received by the recess.

4. The brake shoe assembly of claim 3 wherein the recess defines a slider body engagement surface and the projection defines a clip engagement surface wherein the clip engagement surface engages the slider body engagement surface to prevent removal of the clip from the slider body.

5. The brake shoe assembly of claim 4 wherein the leg is flexible from a first position to a second position wherein the projection is removed from the recess allowing removal of the clip from the slider body.

6. The brake shoe assembly of claim 1 wherein the clip has a base, the base defining an abutment surface in confronting relation to the cam, the base adapted to prevent removal of the pivot pin from the cam through the upper opening.

7. The brake shoe assembly of claim 6 wherein the abutment surface has a convex shape facing the central opening.

8. The brake shoe assembly of claim 1 wherein the clip has a base, the clip having a first flexible leg extending from the base and a second flexible leg extending from the base, the legs engaging the slider body.

9. The brake shoe assembly of claim 8 wherein the first leg has a first projection extending therefrom and the second leg has a second projection extending therefrom, the slider body having an upper portion having a first member and a second member wherein the upper opening is defined therebetween, the first member having a first recess and the second member having a second recess, wherein the first projection is received by the first recess and the second projection is received by the second recess.

10. The brake shoe assembly of claim 9 wherein the first leg is flexible and the second leg is flexible where upon placing the first leg and the second leg in a flexed position, the first projection is removed from the first recess and the second projection is removed from the second recess allowing the clip to be removed from the slider body.

11. The brake shoe assembly of claim 10 wherein the first leg has a first tab extending therefrom and the second leg has a second tab extending therefrom, the tabs being engaged to place the first leg and the second leg in the flexed position.

12. The brake shoe assembly of claim 11 wherein the tabs are engaged simultaneously and moved towards one another to place the first leg and second leg in the flexed position.

13. The brake shoe assembly of claim 11 wherein the base has an extension member extending beyond the first leg and the second leg.

14. A brake shoe assembly for a sash window assembly having a sash window slidably supported within a master frame, the master frame having tracks, the sash window having pivot bar attached thereto, the brake shoe assembly comprising:
a slider body adapted to be received in the track of the master frame, the slider body having a central opening, the slider body further having an upper opening in communication with the central opening, the slide body having a first recess and a second recess;
a cam positioned in the central opening, the cam having a slot, the slot adapted to receive the pivot bar;
a clip having a base, the clip further having a first leg extending from the base and a second leg extending from the base, the first leg having first projection extending therefrom and the second leg having a second projection extending therefrom, the clip positioned in the upper opening wherein the first projection is received in the first recess and the second projection is received in the second recess wherein the upper opening is obstructed preventing removal of the pivot pin from the cam through the upper opening.

15. The brake shoe assembly of claim 14 wherein the clip is removable from the slider body by placing the first leg and the second leg in a flexed position wherein the first projection is removed from the first recess and the second projection is removed from the second recess wherein the clip is removed from the upper opening by moving towards a top of the slider body.

16. An anti-take-out clip for a brake shoe assembly of a sash window assembly having a sash window slidably supported within a master frame, the master frame having tracks, the brake shoe assembly having a slider body received in the track of the master frame, the slider body having a central opening, the slider body having an upper portion having a first member and a second member wherein an upper opening is defined between the first member and the second member, the first member having a first recess and the second member having a second recess, the upper opening being in communication with the central opening, the slider body further having a cam positioned in the central opening, the cam having a slot, the slider body further having a pivot pin attached to the sash window, the pivot pin received in the slot, the anti-take-out clip comprising:
a base having a first flexible leg extending from the base and a second flexible leg extending from the base, the first leg having first projection extending therefrom and the second leg having a second projection extending therefrom, the clip adapted to be inserted into the upper opening from proximate a top of the slider body wherein the first projection is adapted to be received in the first recess and the second projection is adapted to be received in the second recess wherein the clip is adapted to obstruct the upper opening preventing removal of the pivot pin from the cam through the upper opening.

17. A brake shoe assembly for a sash window assembly having a sash window slidably supported within a master frame, the master frame having tracks, the brake shoe assembly comprising:
a slider body adapted to be received in the track of the master frame, the slider body having a central opening, the slider body having an upper portion having a first member and a second member wherein an upper opening is defined between the first member and the second member, the first member having a first recess and the second member having a second recess, the upper opening being in communication with the central opening;
a cam positioned in the central opening, the cam having a slot;
a pivot pin adapted to be attached to the sash window, the pivot pin received in the slot; and
a clip having a base, the clip further having a first flexible leg extending from the base and a second flexible leg extending from the base, the first leg having first projection extending therefrom and the second leg having a second projection extending therefrom, the clip being inserted into the top opening from proximate a top of the slider body wherein the first projection is received in the first recess and the second projection is received in the second recess wherein the upper opening is obstructed preventing removal of the pivot pin from the cam through the upper opening.

18. The brake shoe assembly of claim 17 where upon placing the first leg and the second leg in a flexed position, the first projection is removed from the first recess and the second projection is removed from the second recess allowing the clip to be removed from the slider body.

19. The brake shoe assembly of claim 18 wherein the first leg has a first tab extending therefrom and the second leg has a second tab extending therefrom, the tabs being engaged to place the first leg and the second leg in a flexed position.
